(19) United States
(12) Patent Application Publication
(10) Pub. No.: US 2017/0091688 A1
(43) Pub. Date: Mar. 30, 2017

(54) METHOD AND SYSTEM FOR MAINTENANCE SERVICES PLANNING AND SCHEDULING OPTIMIZATION

(71) Applicant: Embraer S.A., Sao Jose dos Campos-SP (BR)

(72) Inventors: César Sant'ana Cunha LOPES, Sao Jose dos Campos (BR); Claret Laurente SABIONI, Sao Jose dos Campos (BR); Esdras Piraguacy DEMORO, Sao Jose dos Campos (BR); Roberto Smidt HIRSCHMANN, Sao Jose dos Campos (BR)

(21) Appl. No.: 14/871,603

(22) Filed: Sep. 30, 2015

(51) Int. Cl. G06Q 10/06; G06Q 10/00

(52) U.S. Cl. CPC G06Q 10/06314; G06Q 10/20

(57) ABSTRACT

Field services management applicable to industries where the need to define, plan, schedule, coordinate and/or accomplish a number of activities, interventions and maintenance demands is present. Applications include mining, oil and gas, chemical, automotive, aeronautical and others where maintenance planning is considered a challenge. Application to services companies such as transportation, public services, health care and others can be also foreseen.

### CROSS-REFERENCE TO RELATED APPLICATIONS

None.

### STATEMENT REGARDING FEDERALLY SPONSORED RESEARCH OR DEVELOPMENT

None.

### FIELD

The technical field related to the problem and solution presented comprises the area of field services management. In more detail, the technology herein is applicable to industries where the need to define, plan, schedule, coordinate and/or accomplish a number of activities, interventions and maintenance demands is present. This environment is typically found by way of non-limiting example in industries such as mining, oil and gas, chemical, automotive, aeronautical and others where maintenance planning is considered a challenge. Application to services companies such as transportation, public services, health care and others can be also foreseen.

### BACKGROUND

In order to succeed, modern organizations often have to address a number of aspects of their business; some of them are related to the value proposition, product or services strategy, marketing approach, commercial policies, people, and other themes. Operations area also plays an important role and increasingly contributes to the overall results of companies. Concerns about productivity, efficiency and costs are present everywhere.

### BRIEF DESCRIPTION OF THE DRAWINGS

The following detailed description of exemplary non-limiting illustrative embodiments is to be read in conjunction with the drawings of which:

FIG. 1 shows example non-limiting Integrated Planning and the Interests of Operations, Maintenance and Resources Administration;

FIG. 2 shows example non-limiting Basic Elements of Automated Scheduling Optimization Method;

FIG. 3 shows example non-limiting Components of the Automated Scheduling Optimization Method;

FIG. 4 shows example non-limiting Automated Scheduling Optimization Controller: Internal Components and Interfaces;

FIG. 5 shows example non-limiting Automated Scheduling Optimization Method with Inputs from Assets Health Monitoring;

FIG. 6 shows example non-limiting Scenario Assessment Based on Automated Scheduling Optimization Method;

FIG. 7 shows example non-limiting Dynamic Scheduling Optimization Method;

FIG. 8 shows an example non-limiting processor architecture; and

FIG. 9 shows an example of non-limiting flowchart.

### DETAILED DESCRIPTION OF EXAMPLE NON-LIMITING EMBODIMENTS

Many companies, looking for operations efficiency, have invested in modern assets as part of their strategy. This can include new machines, equipment and systems incorporating state-of-the-art technologies and new resources. With modern and expensive assets on hand, the next challenge is how to operate them as efficiently as possible, in order to justify the investments made and to achieve the business' results.

An important issue for operation is asset availability. Often, the goal is to have the assets available to produce all the time. But one knows that any machine, system and equipment is subjected to failures in operation and needs to be repaired, or may even need to be shut down for scheduled maintenance, refurbishment or other interventions from time to time. Such interventions—scheduled or unscheduled—reduce the assets availability. This consequently reduces the overall productivity. The problem can be separated into three parts.

The first part of the problem relates to the assets management: what is the optimum time balance between maintenance and operations that will assure the highest asset availability? On one hand, the equipment may run without stopping for preventive maintenance. However, this situation can lead to failures from time to time, which require unscheduled interventions, interrupts production and reduces asset availability. On the other hand, one may establish periodic maintenance interventions that will prevent failures; but that also affects availability.

The solution to this problem has been addressed by many known methods and systems of predictive maintenance techniques. Condition Based Maintenance and Equipment Health Monitoring are themes well explored by many prior innovations, systems and solutions in the market. Many systems monitor the asset condition in real time, estimate the risk of failure and calculate the impact of that failure in operations, typically in terms of costs. The analysis results in recommendations for decision making support, either for a maintenance intervention or not. Solutions found in the market solve the issue of asset management by integrating two interests: from operations, the necessity to produce goods or services; and from engineering and maintenance, the mission of keeping assets integrity and the risk of failures to acceptable levels.

The second part of the problem is related to the capacity to timely perform and accomplish the recommended maintenance intervention. As the engineering analysis generates a number of maintenance interventions requirements in a number of assets, there will be always a list of services to be performed, called services backlog. This backlog is received in the Planning area, which is responsible to plan and schedule the accomplishment of all required work. In this planning, backlog of any kind of service may include: preventive maintenance, deferred corrective maintenance, predictive recommendations, inspections, adjustments, refurbishments and services in general that require intervention in production equipment. The proposed schedule for accomplishing maintenance generated by the planning may for example consider limitations and constraints, such as calendar limits and interdependencies of services. The schedule can fit into the limited availability of company's resources—manpower and skills of the maintenance team, and materials and tooling required.

The third part of the problem concerns the coordination of planning and scheduling to reconcile demands from maintenance and from other sources such as: equipment improvements, new installations, modifications, compliance of legal requirements and any kind of projects and services in the production system. All those demands compete for the same resources and same physical space in the production system, affecting also business constraints. In the industry today, this situation is not adequately treated. There are different and not integrated systems treating parts of the problem in a disconnected way. Such disconnected, uncoupled solutions can lead to most of the planning, scheduling and accomplishment problems in organizations.

The challenge for planning is often to coordinate among operations, maintenance and resources administration, the timely accomplishment of all different sources of demands in the backlog. There is a natural conflict among operations (which wants to produce), maintenance (which wants to perform recommended interventions) and resources administration (which does not want to be overloaded).

This is a typical problem of integrated operations. Many or most organizations and enterprises have ineffective and inefficient processes to coordinate production, maintenance, planning, scheduling and resources administration in the field services environment.

Prior systems, innovations and solutions in the market only partially address this problem. One kind of prior solution available addresses maintenance and operations areas only. This solution uses health monitoring techniques and algorithms to analyze assets' health condition and determine the priorities and recommendations for maintenance interventions, based on the optimum balance between the risk of failures and production planning demands. However, those solutions do not consider the available resources and organization's capacity to perform recommended interventions.

Another kind of issue solved by known products and systems is the typical problem of resources leveling, which is to find any feasible scheduling solution for the backlog of activities that can be accomplished by the available resources. For example, some prior solutions solve the resources leveling problem by integrating two interests: from engineering and maintenance, the necessity to perform activities to assure assets integrity and reduce the risks of failure; and from resources administration, the constraints and interests of an efficient use of the available resources.

There is not a known solution capable of automatically solving the integrated operations problem that involves simultaneously the three major interests of the field services management: 1) from operations—to attend to required production limits; 2) from engineering and maintenance—to perform required maintenance and other services demands to keep the assets integrity under acceptable risk; and 3) from resources administration—to assure the efficient use of available field resources.

Some enterprises have areas dedicated to coordinate and generate solutions for this conflict. The activity is performed by teams composed by planners and representatives of the areas of interest—operations, maintenance, resources administration and others as required—normally sharing the same physical space. The team can be denominated Integrated Planning, Integrated Operations and other similar names. Engineering and maintenance analysis generates a list of required services and establishes their priorities and suggested dates; their requests may be based on solutions involving reliability analysis, asset management and health monitoring. Planners may use solutions of resources leveling to try to accommodate demands versus capacity of accomplishment. An operations team has its own production targets. In the end, the planners and schedulers generally may need or want to moderate a negotiation among production, maintenance and resources administration in order to attend to the interests of the parties in a feasible scheduling solution.

FIG. 1 represents the Integrated Planning function and three interests involved in the problem: assure production demands and goals, scheduling of interventions, and allocation of resources. Assuring production demands and goals may involve for example producing goods or services required with business demands and goals. In support of this, interventions are scheduled to assure equipment integrity, avoid failures and comply with maintenance strategies, in order to assure equipment safety and integrity. Allocation of resources to perform activities limited to their availability and external constraints assures efficient use of resources.

Such integrated planning processes, as of today, typical rely on a manual, time consuming and ineffective process, many recurrent meetings and strong physical interaction among involved areas, counting entirely on the experience and ability of planners and schedulers to foresee conflicting situations and negotiate with the team to find feasible solutions, many times not attending properly to interests of different areas in the company.

The situations described and faced in companies today can lead to recurrent problems of scheduled versus actually accomplished activities. Most of those issues are related to incapacity to plan and schedule activities in the production system considering all relevant conditions, constraints and resources involved. The problem is bigger as the number of assets, constraints, resources and conditions increases, causing a mismatch between what is scheduled and what is actually accomplished. In certain cases, being aware about the recurrent mismatch, planners and schedulers define on purpose more services than what is really feasible, just to give the field team the possibility to choose and adapt the work as conflicts and surprises appear upon execution. That adds more confusion and inefficiency to the process.

Non-limiting embodiments herein drastically reduce mismatch problems by considering, modeling, integrating and implementing in a consistent method the interests of all stakeholders—production, maintenance and resources administration—assuring optimal feasible solutions.

The non-limiting embodiments herein create a method to automatically solve the full problem of integrating and coordinating operations, asset management and resources administration in a single solution, which optimizes the scheduling of field services considering simultaneously the demands, interests and constraints of those three areas.

Regardless of the inputs given, the example non-limiting embodiments herein assure that the scheduling solution achieved is the one that takes the production system as fast as possible to an operation condition of minimum risks of failures, attending the required production demand and subjected to the available resources and business constraints.

The example non-limiting embodiments eliminate the manual and recurrent work of schedulers in trying to find feasible schedules, and improve drastically the efficacy and efficiency of the planning and scheduling process, reducing the recurrent interactions and negotiations among organization's areas and the Integrated Planning.

An example non-limiting embodiments comprises:
Automated Scheduling Optimization Method
Health Monitoring Integration
Scenario Assessment for Decision Making Support
Dynamic Scheduling Cycle

The example non-limiting embodiments provide the following features and advantages:
the approach of an automated scheduling optimization method used to solve simultaneously inputs from operations, maintenance and resources administration, with optimization criteria developed to assure the achievement of the best feasible services scheduling solution for given scenarios;
the capability to integrate with real time health monitoring data, with diagnostics and prognostics functions, and to update the optimized scheduling solution in accordance with current and future health status of assets of the production system;
embedded methods for decision making support based on assessment of different scenarios and sensitivity analysis, where variations in the resources availability and business constraints lead to different feasible solutions; and
methods for dynamic scheduling cycle integrated with execution management systems assuring updated and coordinated scheduling solutions in accordance with actual and updated accomplishment statuses in the field.

Example Non-Limiting Automated Scheduling Optimization Method

Example non-limiting basic methods to automatically generate optimized scheduling solutions solve a problem of scheduling a list of activities to be performed in a set of assets, organized in a certain production system or services network, considering simultaneously three interests of the organization: 1) maintain production within required limits; 2) maintain the integrity of assets; 3) reduce costs or reduce time through an efficient use of available resources. Optimization is driven by a combination of business rules implemented in the components of the basic method.

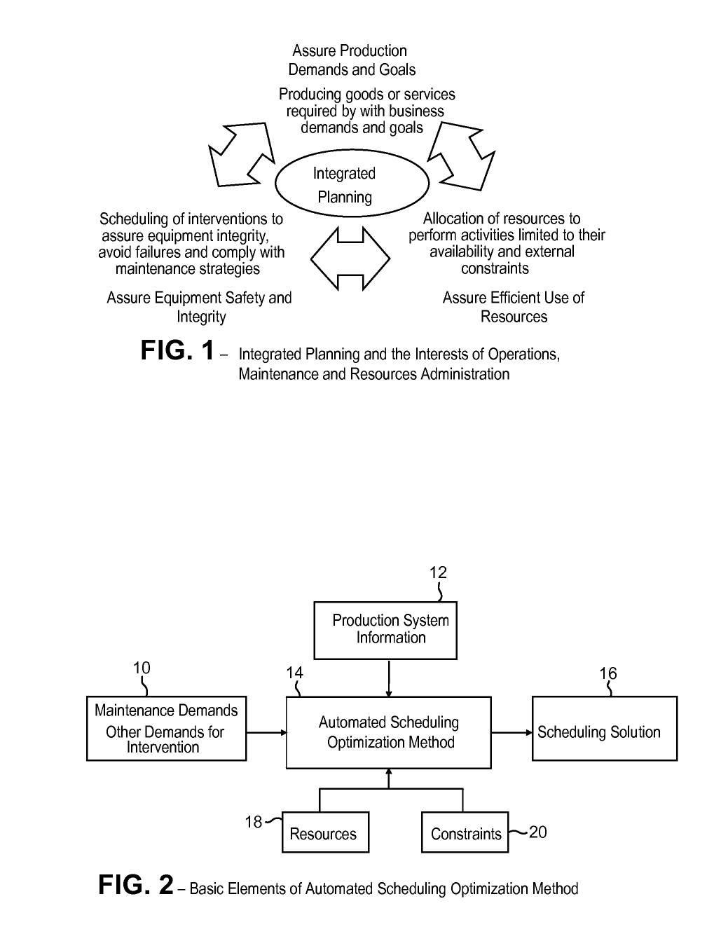

FIG. 2 presents elements of a non-limiting example more basic embodiment. The FIG. 2 more basic embodiment takes 4 inputs:
the demands for intervention 10: composed by any kind of maintenance or other services intervention demands such as repairs, inspections, preventive maintenance, modifications, installations, commissioning etc., that have to be performed in the assets of the production system, consuming some kind of resources and affecting or not production
the production system information 12: contains the description and characterizations of the production system in terms of its architecture, equipment and processes
the available organization's resources 18 to perform demanded maintenance, projects and services
the business' constraints 20 applicable to the planning and scheduling problem.

With given inputs, the example non-limiting automated scheduling optimization method 14 generates an optimum feasible scheduling solution to accomplish the maintenance and other services demands, considering the production demands, the available resources and obeying the business' constraints.

The method consists of modeling and implementing a set of instructions and rules in order to achieve the desired result. The goal of the method is to allocate in the schedule a given list of required activities in accordance with their priorities, obeying their planning parameters, the production demands and subjected to the availability of resources necessary to perform them.

Definitions

Definitions of some standard nomenclature are useful to provide clarity:

“Project”: as used herein, a “Project” comprises set of tasks composing a specific service; this could be for example a maintenance or a service demand and may have one or more tasks; each task inside the project may have relations of precedence or dependence among each other. A project may have planning parameters that define limits of dates and timeframe to be accomplished. The duration of a project may be calculated by the combined duration of its tasks, considering the interrelationship among them. Each project is associated with specific equipment and has a priority index, which is directly related to the estimated risk of equipment failure that is eliminated upon project accomplishment.

“Task”: specific activity inside a project. Each task is associated to specific equipment and brings its attributes of expected duration; necessary manpower (quantity of people and skill); materials and tools used. The task also has a parameter that indicates whether the associated equipment, in which the activity is performed, needs to be out-of-service or not.

“Priority”: a parameter associated with the project that indicates its relative importance in comparison to the other projects in the list of projects to be allocated (planned backlog). Priorities are normally associated with degrees of risk. In example non-limiting embodiments, the projects' priorities can be determined by any combination of different parameters. In cases when there are health monitoring systems providing updated data about current and future assets' degradation and probability of failure, risk can be automatically evaluated as a combination of probability and impact of the failure, which the respective project is supposed to eliminate. Then the project priority assumes the same level of the estimated risk. However, priority can also be driven by other criteria for other projects not directly related to assets' health condition. Priorities for regulatory compliance, inspections, modifications, installations and other projects can be defined by business rules, companies' policies, regulations, etc. In the end, in example non-limiting embodiments, all projects have to have a unified priority index indicating the relative importance among them.

“Resource”: what is necessary to accomplish a task—manpower, materials and tools; resources may be arranged in pools or individually

“Production System”: system of equipment (assets) organized in a defined architecture to produce certain goods or business services, which are the main product of the business organization. The production system contains also a set of integrated processes to drive production.

“Equipment”: any asset in a plant (machines, structures, systems, vehicles, etc.) that contributes to produces goods or business services. Any task is associated to equipment, in which such task has to be accomplished.

End of Definitions

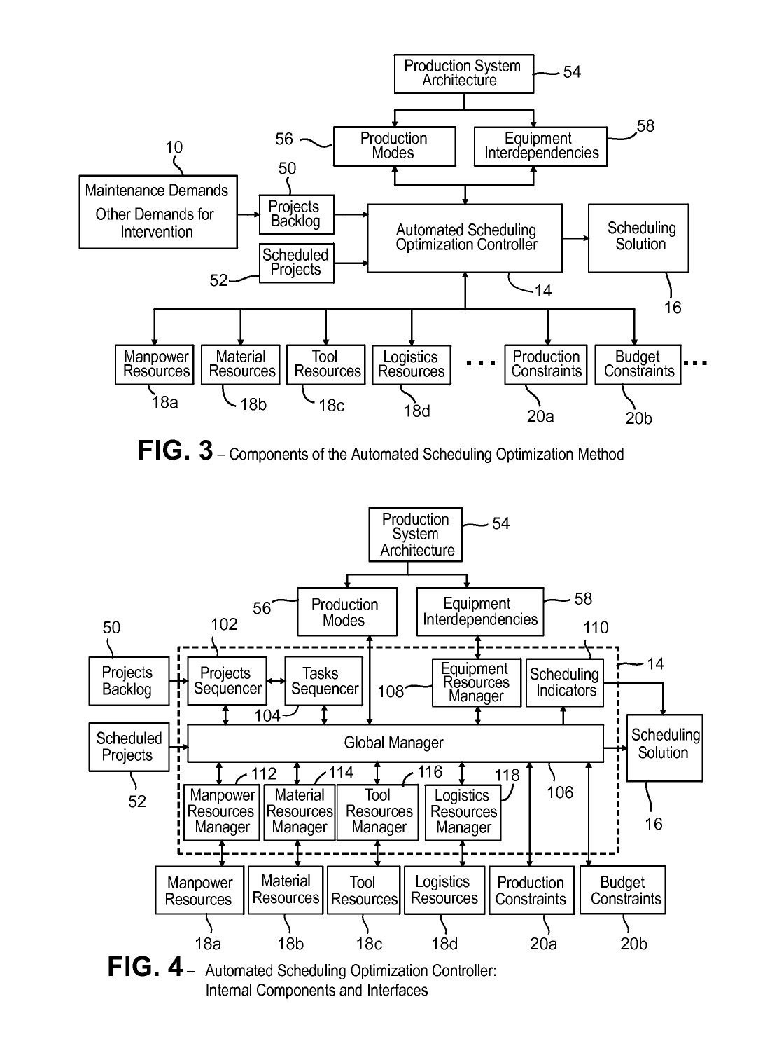

The main components of an example non-limiting embodiment are represented and described in FIG. 3. The core of the example non-limiting method is implemented in the automated scheduling optimization controller 14, which receives the list of activities in the projects backlog 50 and delivers an optimized scheduling solution 16. In order to generate the solution 16, optimization criteria—defined in accordance with the established business rules—are implemented in the automated scheduling optimization controller 14. Resources and constraints, modeled as per the business process, determine the limitations to the scheduling optimization.

Production System Architecture 54: defines the physical and logical disposition of equipment (assets) in a system of production, representing how assets are organized to produce (or deliver) the desired goods (or services). The production system architecture 54 is the basis used in the configuration of production modes and equipment interdependencies, which drives the rules for equipment utilization.

Production Modes 56: represent the plant's production capacity depending on the status of each equipment. The equipment status defines whether the equipment can or cannot operate. The production capacity for each production mode is given in a relative production volume in relation to the standard nominal capacity of the plant, which has all equipment available to operate. Several different production modes (production capacities) may be defined, depending on the plant architecture and the status of each equipment.

Equipment Interdependencies 58: represent the logical or physical relation of interdependencies among equipment in the plant. It is defined in the plant architecture. In practical terms, simple rules are defined indicating the effect of stopping specific equipment in the production plant. Such rules may define, for example, that when certain equipment is out-of-service, other defined equipment have to stop producing as well, as per the plant architecture. Or, in another example, if certain equipment stops, other defined equipment can't be out-of-service as per the operation policies. In practical terms, these criteria are used to determine whether certain equipment can or cannot have a task allocated on it in a certain time slot. The control of equipment resources is performed by the equipment status in the equipment resources manager 108.

Maintenance Demands 10: contains a list of activities originated from preventive, corrective and predictive maintenance. Such activities refer to maintenance plan tasks, inspection routines, defects rectification demands identified in field inspections and recommended interventions recommended by health monitoring processes. Together with the services inputs, all those activities are inputs to the projects backlog 50.

Other Demands for Intervention 10: refer to any demand for intervention in the assets other than maintenance activities. Typically they can be projects and services required to adapt, modify, improve, install new equipment, comply with legal rules, and any other activity that affects assets, competes for resources and physical space in the production system. Together with the maintenance demands, they are inputs for the projects backlog 50.

Projects Backlog 50: contains the input of activities that will be scheduled by the scheduler allocator, comprising the list all projects that are ready to be scheduled and accomplished in the plant. The projects backlog 50 contains all demands for activities to be performed in the equipment—preventive, corrective and predictive maintenance; inspections; adjustments; modifications; installations; refurbishments, etc. Each task in the project backlog 50 contains all attributes, information and parameters necessary for its scheduling.

Scheduled Projects 52: contains the information of activities already allocated in the schedule. Those are the services and tasks previously allocated in the schedule either by manual allocation or by former solutions, previously generated by the system. In both cases, those are activities that are not subjected to the allocation by the automated scheduling optimization controller 14. However, this information shall be considered since tasks already schedule consume resources and impact the business' constraints anyway, which shall be considered for allocation of new projects in the projects backlog 50.

Manpower Resources 18a: represents the administration of the workforce used to perform the tasks. It controls the allocation of available people or pool of technician, considering the given skill and shift hours of each worker, as well as the slots of time already allocated to other tasks. The manpower resources manager 112 interacts with the automated scheduling optimization 14 to determine available slots of workforce where tasks can be allocated.

Material Resources 18b: represent the administration of the material used to perform the tasks, considering the given stock levels and the type and quantity of parts required to accomplish a given task. The material resources manager 114 interacts with the automated scheduling optimization to determine available slots of materials where tasks can be allocated.

Tool Resources 18c: represent the administration of the tools used to perform the tasks, considering the given availability of tools in the plant and the type and quantity of tools required to accomplish a given task. The tool resources manager 116 interacts with the automated scheduling optimization 14 to determine available slots of tools where tasks can be allocated.

Logistics Resources 18d: represent the administration of logistics in the production system necessary to accomplish a certain project. This kind of resource may be, for example: physical space in the area around equipment where the services are being executed; physical space to accommodate temporarily people or materials or tools that are involved in the project (people on board is a typical situation); physical space for transportation of required people, material or tools to accomplish the service. There could be more than one type of logistics resources involved in the problem; in this case, many logistics resources managers 118 can be created. The logistics resources managers 118 interact with the automated scheduling optimization 14 to determine available slots of logistics resources when tasks can be allocated.

Production Constraint 20a: defines the production target for the company. The target is defined in terms of accumulated volume of goods (or services) produced (or delivered) along a period of time and in a daily basis. This constraint may limit the allocation of activities that require equipment out-of-service for intervention.

Budget Constraint 20b: defines a limit for total budget that may be spent in accomplishing activities in the plant in a period of time. Tasks may require budget for accomplishment.

Automated Scheduling Optimization Controller 14: performs the core function of allocating the projects of the backlog into an optimum schedule for accomplishment. The scheduling method is implemented in the automated scheduling optimization controller 14. In one embodiment, controller 14 can be implemented as shown in FIG. 8 by one or more processors 500 executing software instructions and consuming data stored in non-transitory storage 506, and communicating via a network communications adapter 502 with other equipment via a network 504 and providing display information to one or more display devices 508.

FIG. 4 details the internal components of the automated scheduling optimization controller 14. The method implemented in the automated scheduling optimization controller 14 consists of solving the projects and tasks allocation problem in five layers and in a sequence of steps, including optimization criteria defined by the business rules. The layers and steps method assures consistency of the optimized solution for the given problem.

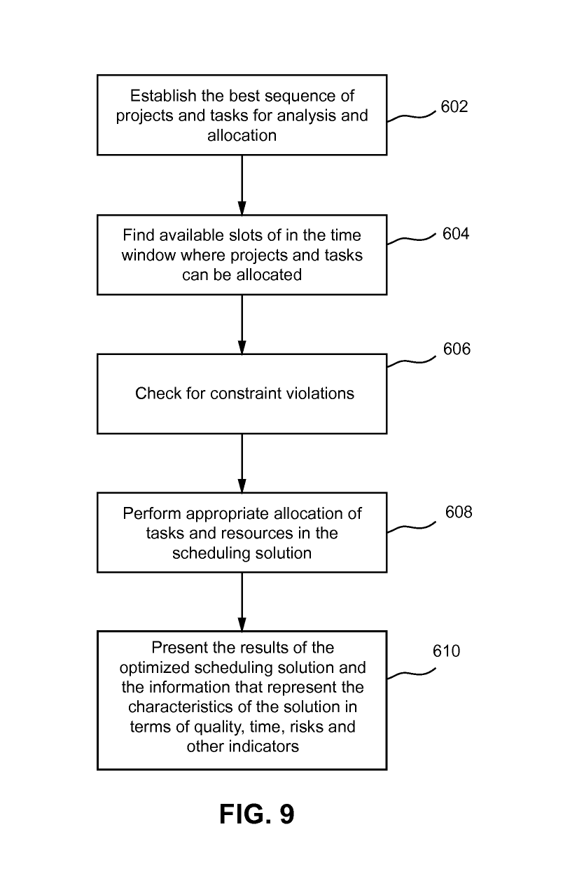

In the first layer (FIG. 9, block 602), the method establishes the best sequence of projects and tasks for analysis and allocation. The criteria for sequencing are established by the business' rules. In the case of this method, the criteria refer to the minimization of the risk of failure in the assets of the production system. Therefore, demands with higher priorities are allocated first.

In the second layer (FIG. 9, block 604), the method finds available slots of in the time window where projects and tasks can be allocated. In this method, the slots have to be selected in accordance with the project or task planning limitations (due dates, dependences, precedencies, etc.) and availability of all resources necessary to perform the activities.

In the third layer (FIG. 9, block 606), the method checks for the constraints violations. A number of constraints can be included. In the method presented, constraints of minimum production and maximum budget are modeled.

In the fourth layer (FIG. 9, block 608), the method performs the appropriate allocation of tasks and resources in the scheduling solution.

In the fifth layer (FIG. 9, block 610), the method presents the results of the optimized scheduling solution and the information that represent the characteristics of the solution in terms of quality, time, risks and other indicators.

Layer 1

Projects Sequencer 102: the projects sequencer assures the optimization criteria to reduce as fast as possible the risk of failures in equipment of the production system. The project sequencer 102 takes the projects backlog and defines the optimum sequence for projects allocation. The criterion for sorting prioritizes first the allocation of projects that most contribute to reduce the risk of equipment failures. Such criterion considers multi objective aspects such as, but not limited to: equipment probability of failure; impact of equipment failure; type of project; internal or external policies and regulations; production opportunities and others. Assuming that the priority indicated in each project is related to the risk of a potential failure in the associated equipment, the sorting criterion establishes that the most critical projects have to be allocated first. In order to eliminate the risk of failures faster, taking projects with the same priority, the ones with shorter duration shall be allocated first. That generates the list of projects (backlog) sorted by priority and duration. The first project of the list is the one that is allocated first by the global manager. The project sequencer 102 delivers a list of sorted projects to the tasks sequencer 104.

Tasks Sequencer 104: taking a selected project from the list of sorted projects defined by the projects sequencer 102, the tasks sequencer 104 defines the sequence of tasks of this project to be allocated. A project may have one or more tasks. The tasks sorting criterion considers that the tasks that are in the critical path of the project have to be allocated first, obeying also the interrelationship among them (tasks precedencies and dependencies). The tasks sequencer 104 delivers tasks to the global manager for allocation.

Layer 2

Manpower Resources Manager 112: considering the manpower resources 18a necessary to perform the tasks (skill and quantity of people), the manpower resources manager 112 interacts with the global manager 106 and controls all the information about available and allocated slots for each worker individually. It takes as input the informed availability of workers given by the manpower resources constraints and, when asked by global manager 106, it informs manpower slots availability. Also, when requested by global manager 106, the manpower resources manager 112 confirms and updates manpower allocation, assigning workers to specific tasks and dates.

Material Resources Manager 114: considering the material necessary to perform the tasks (type and quantity), the material resources manager 114 interacts with the global manager 106 and controls the information about availability of dates when there are materials available to be used. It takes as input the initial availability of material informed by the material resources constraints and, when asked by global manager 106, it informs the materials slots availability. Also, when requested by global manager 106, the material resources manager 114 confirms and updates allocation, assigning materials to specific tasks and dates.

Tool Resources Manager 116: considering the tools necessary to perform the tasks (type and quantity), the tool resources manager 116 interacts with the global manager 106 and controls the information about availability of dates when each tool is available to be used. It takes as input the initial availability of tools informed by the tool resources 18c constraints and, when asked by global manager 106, it informs the tools slots availability. Also, when requested by global manager 106, the tool resources manager 116 confirms and updates allocation, assigning tools to specific tasks and dates.

Logistics Resources Managers 118: considering logistics resources 18d necessary to perform the tasks, the logistics resources managers 118 interact with the global manager 106 and control the information about availability of dates when each type of logistic resource 18d is available. Taking as input the initial availability of logistics resources 18d, when asked by global manager 106, the logistics resources managers 118 inform the logistics resources 18d availability. Also, when requested by global manager 106, the logistics resources managers 118 confirm and update allocation, assigning logistics resources 118 to tasks and dates.

Equipment Resources Manager 108: for the purpose of this method, the equipment resources manager 108 considers that the equipment in the plant is as kind of “resource” used by tasks that require the equipment out-of-service. In other words, for the tasks which require the equipment out-of-service, the given task “uses” the associated equipment for the duration of task, meaning that the equipment has to be out-of-service during the accomplishment of the task and is not available to produce.

The equipment resources manager 108 addresses the “usage” of equipment by tasks that require equipment out-of-service. Such control is made by setting different status for the equipment along the time. The equipment status can assume one of the three possibilities: “available to operation”; “out-of-service”; or “locked”.

The standard status of equipment is “available to operation” meaning that it can be considered by the production modes as available for producing. “Out-of-service” status means that the equipment is not available to produce.

The equipment status is set as “out-of-service” in the following situations:
Whenever a task that requires equipment A out-of-service is allocated in the schedule, the associated equipment A status is set as “out-of-service” for the duration of the task.
The “out-of-service” status can also be determined by the rules established in the equipment interdependencies. In this case, a given equipment A is set out-of-service whenever there is another equipment B out-of-service and there is an interdependency rule establishing that equipment A status has to be set “out-of-service” whenever equipment B is out-of-service.
The equipment status is also set as “out-of-service” when informed manually that an external intervention is allocated in the equipment for the duration of such intervention.

The “locked” equipment status is determined by rules established in the equipment interdependencies:
A given equipment A status is set as “locked” whenever exists another equipment B with status “out-of-service” and there is an interdependency rule indicating that, whenever equipment B is out-of-service, tasks that require equipment A out-of-service cannot be allocated in the schedule. In this situation equipment B “locks” equipment A for the duration while equipment B is out-of-service. With the “locked” status equipment is available to produce.

The equipment resources manager 108 controls the status of each equipment along the time of the schedule and interacts with the global manager 106, informing slots available to allocate tasks (that require associated equipment out-of-service) and also updating the equipment status, as applicable, whenever a task is allocated in the schedule. The slots are considered available for task allocation whenever and for the duration while the equipment status is “available to operation” or “out-of-service”. Equipment status “locked” does not create a slot for task allocation.

Layer 3

Global Manager 106: controls and manages the process of tasks allocation in the schedule, interacting with the projects and tasks sequencers 102, 104; manpower, materials, tools and logistics resources managers 18a, 18b, 18c, 18d; equipment resources manager 108; production and budget constraints 20a, 20b; and delivers the results to the scheduling indicators 110 calculator and scheduling solution 16.

The global manager 106 receives the list of scheduled projects, which are firm services and tasks already allocated in the schedule either by manual process or by any other means of allocation. The global manager 106 takes the scheduled projects information and assures with the resources managers 112, 114, 116, 118 that the required resources for those activities are already allocated as demanded. The global manager 106 also calculates the impact of the scheduled projects in the production constraint 20a and budget constraint 20b prior to start allocating new activities. This scenario, with resources already allocated for the scheduled projects 52 and impact in constraints considered, is the initial condition for the global manager 106 to start allocating new activities.

The global manager 106 receives tasks from the tasks sequencer 104 for allocation. Tasks are already furnished in a list sorted by the criteria implemented in the tasks sequencer 104 and projects sequencer 102.

The global manager 106 checks the task planning limitations, which may be date limits to start or to finish the activity—as per information obtained in the task attributes—and/or may be imposed by interdependencies rules established with other tasks already allocated in the schedule. That analysis defines the initial possible windows of time when the task can be allocated in the scheduling window.

The global manager 106 asks the manpower, material, tool, logistics and equipment resources managers 18a-18d, 108 to inform all their individual windows of time when the resources required by the task are available. The global manager 106 receives the information from each manager and calculates the intersection of time (windows) when all necessary resources are available at the same time. The global manager 106 compares the windows resulting from this intersection to the task duration and generates a list of all possible slots in the schedule when the task can be allocated. The global manager 106 selects the allocation slot from this list as per the “as soon as possible” criteria. If no possible slots are found, then the task cannot be allocated.

Layer 4

Production Constraints 20a and Budget Constraints 20b: the global manager 106 checks the production and budget constraints 20a, 20b for absence of violation. If there is any violation, the global manager 106 looks for the next slot in the list of all possible slots where the task can be allocated, defined in the previous step. The constraints violation check is performed again, and the process follows until a slot is found that do not cause any constraint violation. If all possible slots in the list cause constraint violations, the task cannot be allocated.

For the production constraints violation check, the global manager 106 verifies the status off all equipment along the schedule—given by the equipment resources manager 108—and compares to the defined production modes in order to obtain the volume of production for each slot of time in the scheduling window. The global manager 106 calculates the total production of the plant along the time and compares to the production levels required and defined by the production constraints.

When the constraints violation check succeeds, the global manager 106 confirms the allocation of that task in the defined slot and requests to the manpower, material, tool, logistics and equipment resources managers 112, 114, 116, 118, 108 to allocate their specific resources to the defined slot of time for the duration of task.

The global manager 106 takes the next task or project in the list sorted by the task sequencer 104 and performs the same steps for task allocation until all tasks and projects have been processed. In the end, the global manager 106 sends the scheduling information to be calculated in scheduling indicators 110 and to be presented in the scheduling solution 16.

Layer 5

Scheduling Solution 16: the results delivered by the global manager 106 consist of: the start date, duration and priority of all allocated tasks; a list of not allocated tasks; occupation of each resource along the scheduling window; production volume achieved and budget consumed along the scheduling window.

Scheduling Indicators 110: calculates key performance indicators (KPI) of the scheduling solution 16 generated by the global manager 106. A combination of scheduling solution indicators is used as a reference method to evaluate the quality of a scheduling solution. The quality is measured in terms of feasibility, efficiency and efficacy of a given scheduling solution. Indicators and metrics embrace, but are not limited to the evaluation of: capacity to eliminate risk of equipment failures; efficiency of resources allocation; production demands compliance; budget compliance; logistics efforts; and others.

The scheduling solution 16 results and scheduling indicators 110 may be presented graphically in a Gantt chart, tables and specific charts as required by business' rules.

Health Assessment Integration

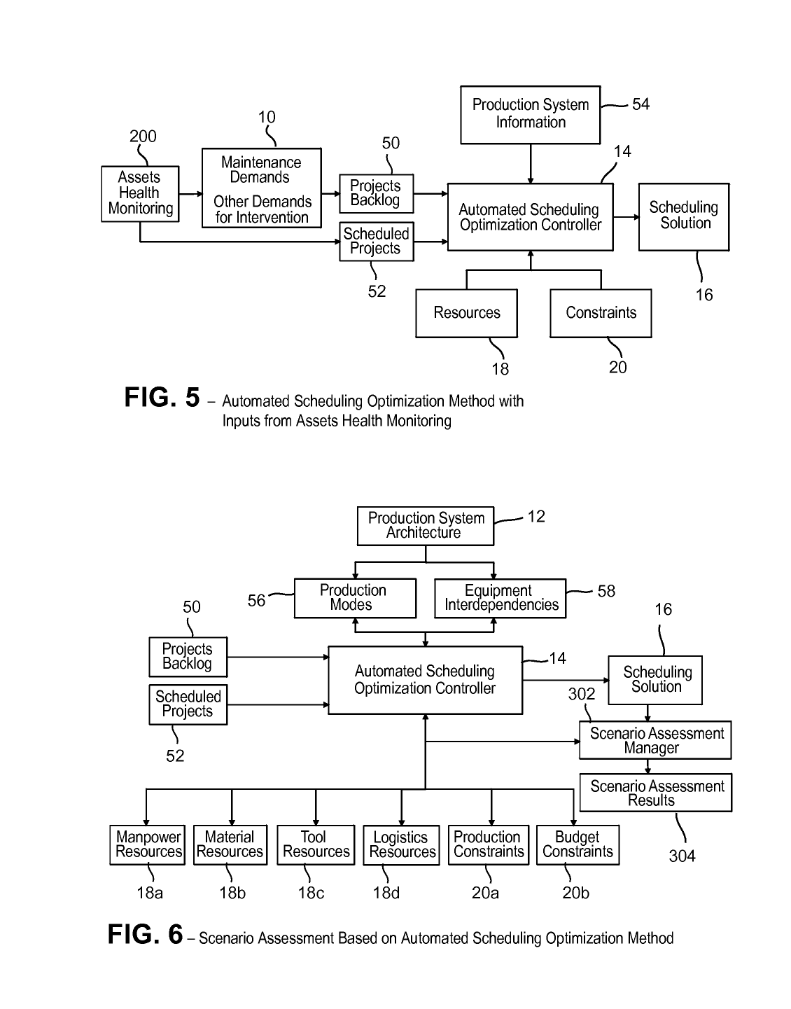

Another example non-limiting embodiment comprises the integration of the Automated Scheduling Optimization Method described above with assets health monitoring systems 200 as described in FIG. 5.

The assets health monitoring systems 200 generate information about the health condition of assets in the production system.

Any system and method for performing the monitoring of assets' health condition 200 can be used to define new maintenance demands 10, which are validated and refined by maintenance engineers to be included in the projects backlog 50 for automated scheduling.

For maintenance demands already included as scheduled project 52, the assets health monitoring systems 200 also provide important information, updating parameters that determine the assets' risk of failure, which serves as one criterion for defining the priority of that scheduled project.

The integration of the Automated Scheduling Optimization Method with assets health monitoring systems also comprises features of prognostics of equipment failures. Prognostics information is given as a forecast of equipment health condition estimated for each future point in time. The information may be provided by a vector containing either a forecast of equipment degradation index or probability of failure for a set of future instants in time. The Automated Scheduling Optimization Method interprets the data set of equipment's forecast health condition in each future time and uses this information to adjust a dynamic priority along the future time for the associated maintenance demand. The scheduling solution 16 provided by the automated scheduling optimization controller 14 considers the dynamic effects of projects priorities determined by prognostics features of assets' health monitoring systems.

Scenario Assessment

Example non-limiting solutions also embrace an independent scenario assessment method 302, 304 of FIG. 6, which is also implemented and performed based on the scheduling solutions generated by automated scheduling optimization method.

The scenario assessment considers variations in availability of resources and modifications in business constraints. The objective of such assessment is to perform a sensitivity analysis to verify impact of variations in the resources availability and/or in the business' constraints, as applicable, to support evaluation of other possible scheduling solutions.

Once a scheduling solution is generated by the basic automated scheduling optimization method 14, an independent function 302 is applied in order to simulate other viable solutions for a number of different scenarios and to perform a sensitivity analysis with regards to resources and constraints variations. The objective is to vary resources availability and business' constraints parameters in order to evaluate the impact in the scheduling solutions generated and theirs parameters (scheduling indicators). This function is performed by the scenario assessment manager 302 as represented in FIG. 6.

Scenario Assessment Manager 302: the scenario assessment manager receives data from the scheduling solution and interacts with the automated scheduling optimization controller and with the resources and constraints. The scenario assessment manager 302 sets the variation parameters in manpower, material, tool and logistics resources, and modifies production and budget constraints. For each variation and modification set, the scenario assessment manager 302 requires another solution to be generated by the automated scheduling optimization controller 14. By varying the resources availability and constraints and analyzing different solutions generated, the scenario assessment manager 302 provides a sensitivity analysis for resources and constraints, which is delivered as scenario assessment results.

Scenario Assessment Results 304: the scenario assessment results 304 present all the outputs provided by the scenario assessment manager that are necessary to support the decision making of planners, schedulers and managers responsible for the organization's results.

Continuous and Dynamic Scheduling

Planning and scheduling is a continuous process, which can be updated regularly as services are being accomplished in the field and new demands are being identified. The recurrent cycle of planning and scheduling services depends on the feedback from the field to update the accomplishment status of activities.

The automated scheduling optimization method integrates with execution management systems in order to obtain the actual accomplishments made by the workforce in the field. That allows the analysis of planned versus executed services and serve as inputs for new maintenance or services demands and for rescheduling of activities not completed.

The execution management system 400 provide inputs of new maintenance and services demands to be included in the projects backlog and also provide updated accomplishment status for scheduled projects, which comprise projects already scheduled as per scheduling solutions previously generated.

The automated scheduling optimization 14 runs every time with updated information furnished by execution management systems 400. Activities that are accomplished and finished are removed from the scheduled projects list. Activities initiated but not finished remain in the scheduled projects and may have its parameters updated as per field information. New demands originated from the field are included in the projects backlog after proper planning.

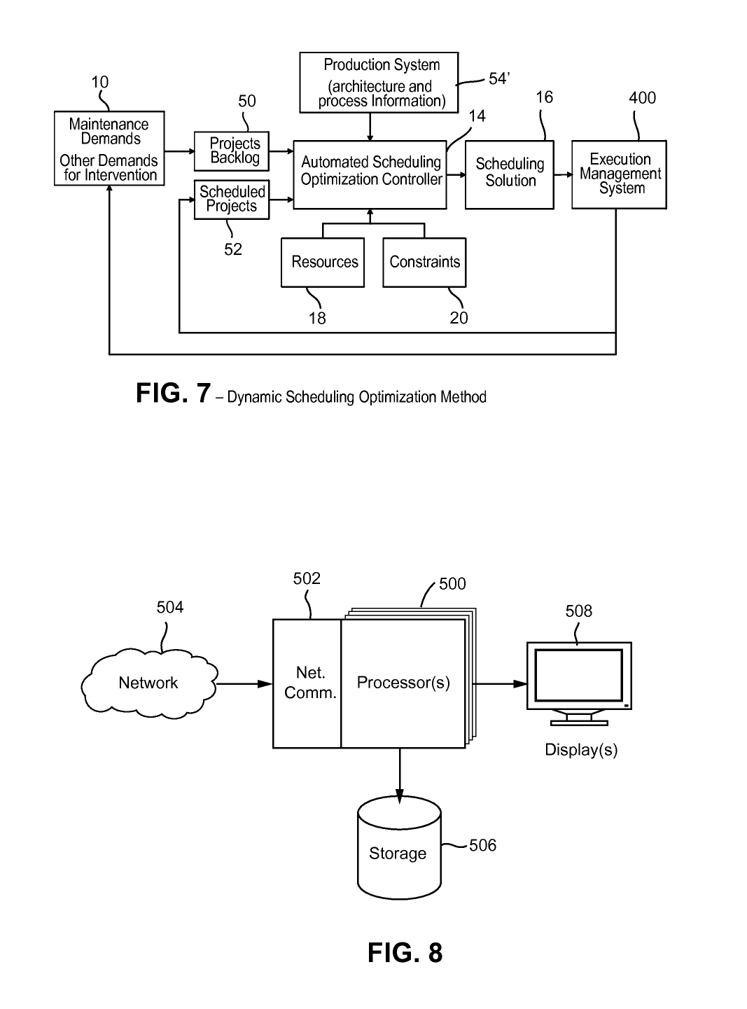

FIG. 7 represents the integration of execution management systems 400 with the automated scheduling optimization method 14. While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A system for integrating automated scheduling with assets health monitoring systems and prognostics of equipment failures, comprising:
a global manager connected to a projects sequencer, a tasks sequencer, an equipment resources manager, scheduling indicators, and at least one resources manager, the global manager comprising at least one processor executing code configured to control the processor to perform at least the following:
receiving prognostics information as a forecast of equipment health condition estimated for each of a plurality of future points in time, the received prognostics information comprising a vector containing at least one of (a) a forecast of equipment degradation index and (b) probability of failure for a set of future instants in time;
based at least in part on the received prognostics information, interpreting a data set of equipment's forecast health condition in each of the plurality of future points in time;
using the interpreted data set to adjust future dynamic priorities for associated maintenance demands; and
generating a scheduling solution that considers the dynamic effects of projects priorities determined by prognostics features of assets' health monitoring systems.

2. An integrated system for scheduling projects in a production system, considering simultaneously maintenance and services demands, operations demands and resources administration interests, the integrated system comprising:
an automated scheduling device coupled to receive (a) maintenance demands and (b) information related to resources and constraints;
the automated scheduling device including at least one processor configured to automatically develop scheduling solutions for a production system based at least in part on production system information and on the received maintenance demands and information related to resources and constraints.

3. The integrated system of claim 2 further including modeling production system architecture and management of production demands, considering plant topology, equipment interdependencies, production modes and production constraints.

4. An optimization method, implemented in an automated scheduling optimization controller and associated components, comprising:
developing a scheduling solution that assures an increase in the speed of a production system to an operation condition of reduced risks of failures,
the developing attending to maintenance and production demands,
subjecting the scheduling solution to the available resources and business constraints, and
consistently solving the projects and tasks scheduling problems in developing the scheduling solution.

5. A method comprising:
automatically, with at least one processor, evaluating the quality of a scheduling solution based on a number of indicators and metrics that determine the feasibility, efficiency and efficacy of a provided scheduling solution;
the indicators and metrics including evaluation of: capacity to eliminate risk of equipment failures; efficiency of resources allocation; production demands compliance; budget compliance; and logistics efforts.

6. A method of integrating automated scheduling optimization with real time health monitoring systems with diagnostics and prognostics features, comprising:
using real time diagnostics to update an optimized scheduling solution in accordance with current health status of assets of a production system; and
generating an optimized scheduling solution based on the prognostics of assets health condition, wherein forecasting assets health condition in each future instant in time, given by a health monitoring system, modifies a priority of a project along the time.

7. An embedded method for decision making support based on the assessment of multiple scheduling scenarios and identification of critical resources and constraints, including sensitivity analysis where variations in the resources availability and business constraints lead to different feasible solutions.

8. A method for the cycle of dynamic scheduling integrating the automated scheduling optimization with execution management systems assuring continuously updated and coordinated scheduling solutions in accordance with actual and updated accomplishment statuses in the field.
